(19) United States
(12) Patent Application Publication
(10) Pub. No.: US 2006/0038691 A1
(43) Pub. Date: Feb. 23, 2006

(54) Window mounted rescue assistance apparatus

(76) Inventor: Ronald Bard, Hopewell Junction, NY (US)

Correspondence Address: SHUGHART THOMSON & KILROY, PC, 120 WEST 12TH STREET, KANSAS CITY, MO, 64105, US

(21) Appl. No.: 11/166,859

(22) Filed: Jun. 24, 2005

Related U.S. Application Data
(60) Provisional application No. 60/592,644, filed on Jul. 30, 2004.

(51) Int. Cl. G08B 17/10; G08B 1/00; G08B 1/08

(52) U.S. Cl. 340/628; 340/531; 340/539.1

(57) ABSTRACT

An emergency notification device is provided in which a first warning unit detects the audible warning alarm emanating from an activated smoke detector, the first unit then sends a radio frequency signal to a second, window mounted, warning unit that provides a flashing light and sound notification to emergency personnel outside of a dwelling to indicate that persons or pets in need of rescue are located within the room in which the warning unit is located.

### CLAIM OF PRIORITY

This application claims priority to U.S. Provisional Application Ser. No. 60/592,644 filed Jul. 30, 2004.

### FIELD OF THE INVENTION

This invention relates to the field of home or dwelling emergency safety. In particular the present invention relates to devices for providing notification to emergency personnel, and others offering assistance during a dwelling emergency, that a person and/or pet is located within the dwelling or a particular room of the dwelling. This is accomplished, generally, by the use of a noise detector which is activated by the sounds emanating from an activated smoke detector. Upon activation, the noise detector sends a signal to a display unit that previously has been placed against a window. Upon receipt of the signal the display unit can sound an audible alarm and can start a number of lights flashing which can be observed from outside the dwelling.

### BACKGROUND OF THE INVENTION

A smoke alarm device or smoke detector comprises a housing having vents to allow flow of surrounding air into and out of the housing, an alarm indicator means typically including a sound emitter (horn), a smoke sensor, and a control circuit which monitors the sensor output to determine if smoke is present and activates an alarm if smoke is present. The most common smoke sensors are of the optical and ionized particle types.

Smoke detectors detect the presence of smoke particles as an early indication of fire. Devices known as “smoke detectors” also may be equipped to detect the excess heat associated with the presence of a fire. Both types of detectors are contemplated herein by the references to “smoke detectors.” Smoke detectors are used in closed structures such as houses, factories, offices, shops, ships, aircraft, and the like. Smoke detectors may include a chamber that admits a test atmosphere while blocking ambient light. A light receiver within the chamber receives a level of light from an emitter within the chamber, which light level is indicative of the amount of smoke contained in the test atmosphere.

A smoke detector is most useful when it is located in a hallway so that it may sample the circulating air and determine, at an early moment after combustion begins, that smoke from a fire is present in the circulating air. Therefore, while smoke detectors are useful for issuing an alarm to the occupants that a fire is burning, they provide no information to rescuers who are attempting to locate occupants or pets in need of assistance in exiting the burning building.

It therefore would be useful if a notification device were available which could respond to the activation of a smoke alarm to provide rescue workers with an indication or notification of the location of occupants within a dwelling and/or the type of occupants, such as humans or pets, which were located in the particular area of the building. The present invention solves this problem by sensing the audio portion of the smoke detector alarm and becoming activated in response to the detection of the audio alarm from the smoke detector to signal a secondary unit which begins to issue a visible and audible alert to rescuers.

### SUMMARY OF THE INVENTION

The present invention functions, generally, by providing a first unit 10 (FIGS. 7 and 8) which is comprised of a battery powered sound receiver that detects the audible signals from a smoke detector by sensing the noise generated by the smoke detector upon it being activated by smoke in the dwelling. The sound receiving and transmitting unit, or first unit 10, responds to the audible alarm given off by the smoke detector and sends a wireless signal in the form of a radio frequency signal to one or more alert devices 50 (FIGS. 1-6). The alert devices 50, when activated, provide a visible flashing light alarm 60, 62 (FIG. 2) and/or an audible noise alarm to indicate to rescuers the presence of persons or pets within a particular location of the dwelling. The alarm device of the present invention is provided with two different colors of flashing lights or light emitting diodes (LEDs). In a preferred embodiment, such as that shown in FIG. 2, red and blue LEDs, as flashing lights or steady lights, are used to provide a visual signal to rescue personnel. A first color, red for example, may be used to indicate the presence of humans and a second color, blue for example, may be used to indicate the presence of pets within the room in which the warning device is located.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is an environmental view showing the receiver and display device 50 of the present invention adhered to a window pane by the suction cups attached to the bottom of the receiver and display device;

FIG. 2 is an elevation view of the back face of the device of FIG. 1 showing the suction cups on the device and showing the light bulbs or light emitting diodes LEDs which provide a flashing light signal to rescuers;

FIG. 3 is a top side view of the receiver and display device of the present invention shown in FIG. 1;

FIG. 4 is a front face elevation view of the device of FIG. 1;

FIG. 5 is a bottom side view of the device of FIG. 1 and showing the suction cups attached to the back face of the device;

FIG. 6 is a right side and bottom and front face exploded perspective view of the device of FIG. 1 and showing the relative positions of the suction cups, bottom housing, blue reflector, red reflector, printed circuit board containing the light emitting diodes, the top housing and switches and batteries which are contained within the unit;

FIG. 7 is a front face view of the sound detector and sending unit of the present invention;

FIG. 8 is a top side view of the sound detector and sending unit of FIG. 7;

FIG. 9 is a flowchart showing the sequence of activation of devices which operate in combination in the present invention.

FIG. 10 is a flowchart showing operational steps in the method of operation of the present invention in combination with a smoke detector.

### DESCRIPTION OF THE PREFERRED EMBODIMENT

As required, detailed embodiments of the present inventions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

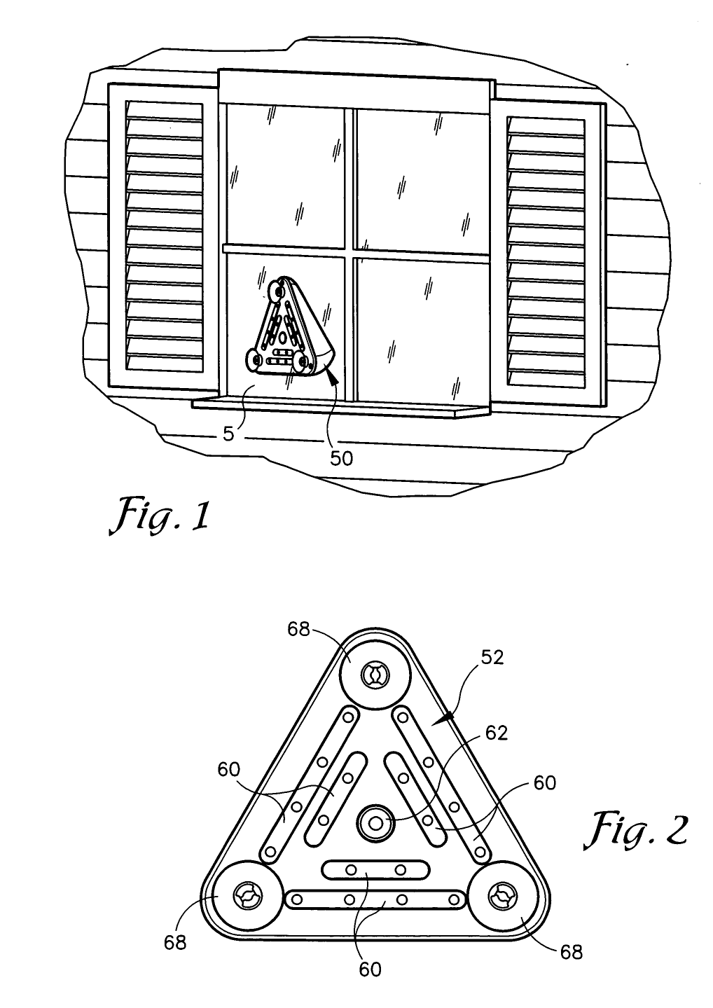

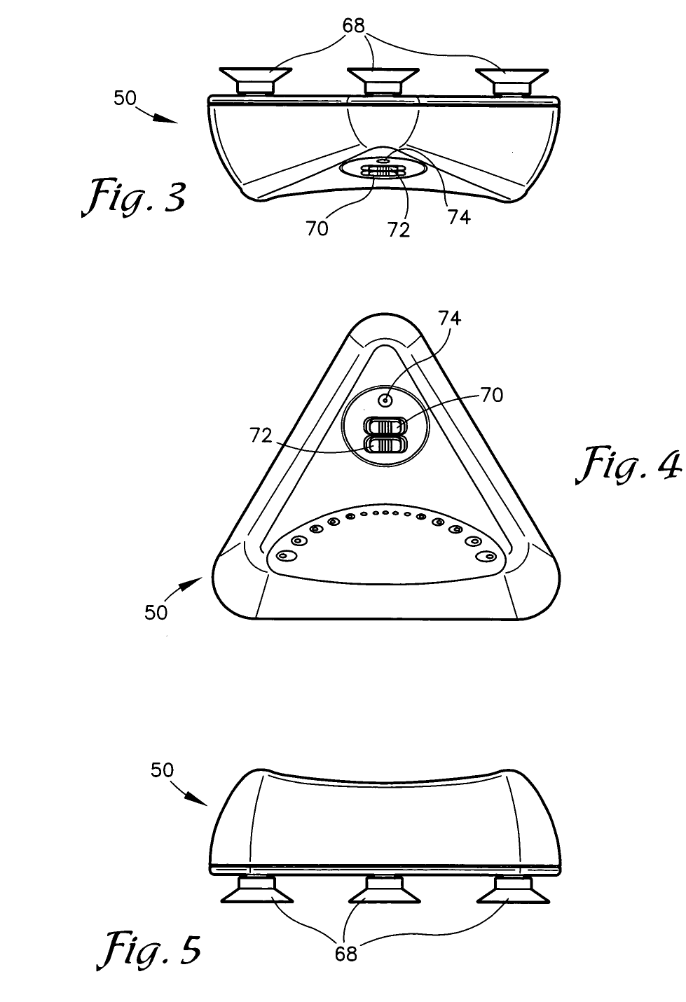

The present invention is comprised of two separate units, a receiver/sending unit 10 which also may be referred to as first unit 10 or as a receiver/transmitter unit 10 (FIGS. 7 and 8) and a receiver/display unit 50 or second unit 50 shown in FIGS. 1-6. The first and second units operate together to detect the alarm that is sounded by a conventional smoke detector and to respond to that alert by activating lights or light emitting diodes (LEDs) which provide a visual alert to rescue personnel, on the outside of a dwelling, of the particular room or rooms of a dwelling that contain persons and/or pets in need of rescue assistance.

First referring to FIG. 1, second unit 50, the receiver/display unit 50, of the present invention is shown affixed to a window pane 5 in the interior of a dwelling. This positioning of the receiver/display unit 50 allows an alert or indication to be displayed to persons outside of the dwelling of the room location of dwelling occupants. This alert or notice is particularly beneficial to and is directed toward fire department emergency personnel who arrive to assist with the evacuation of the burning building. In particular parents may place receiver/display unit 50 in the window of a child's bedroom to notify emergency personal, when they arrive at the residence, of the rooms that are likely to contain children and/or pets. The receiver/display unit 50 is mounted onto any window or surface that may be observed from the outside of the dwelling. Mounting, in a preferred embodiment, is by the use of suction cups 68 (FIGS. 2 and 3 and 5) that are attached to back face 52 of receiver/display unit 50. It will be appreciated by those skilled in the art that receiver/display unit 50 could be mounted directly to the outside wall of a building near a location inhabited by humans or pets. This alternative embodiment is accomplished by use of any convenient mounting means such a bracket or glue or fasteners such as nails bolts or screws that can hold receiver/display unit 50 in a position that is visible to those outside the dwelling. It is of course critical that, in such alternate positions and the receiver/display unit 50 be tested to be sure that it can receive the intended Rf signal from receiver/sender unit 10.

It should be appreciated that the present invention is not a smoke detector and cannot, by itself, detect any kind of smoke or fire. The present invention operates in conjunction with any standard smoke alarm that generates an audible warning to the occupants of the dwelling. The present invention is comprised of a first sound detection and radio frequency transmitter unit 10 (FIGS. 7-8) and a second radio frequency receiver and display or warning unit 50 (FIGS. 2-6). It will be appreciated that the present invention is particularly suited to use in travel situations in which the noise emitted from a pre-existing hotel smoke detector can be detected by receiver/sender unit 10 which can then activate receiver/display unit 50 which has been attached to a hotel room containing children. In particular, this use of the present invention may be helpful when the children are in a adjoining room relative to the children's parents.

In operation, the sound detection and radio frequency transmitter unit 10, or first unit 10, detects and responds to the noise emitted from an activated smoke detector. It will be appreciated by those skilled in the art that such detection and response can be based on loudness of the noise (e.g. decibel detection) or based on sensing a particular frequency or frequency range of the noise emitted by the smoke detector. Upon detection of the audible alarm emitted by a smoke detector, first unit 10 then transmits a radio frequency signal to the radio frequency receiver and warning unit 50, or second unit 50. The second unit 50 responds to the received radio frequency signal sent from first unit 10 by generating an audible warning noise and/or by initiating a flashing light signal.

It may seem duplicative of the smoke detector warning to issue a second audible warning noise from second unit 50, however, travelers will appreciate that the noise emitted by an unfamiliar smoke detector may not always be immediately recognized or associated with a fire emergency. Also, children, in particular, may not recognize the noise made by a strange smoke detector. Thus, children may be delayed in responding to the warning given by, for example, a hotel smoke detector or they may not respond at all. As the present invention also can emit a noise in response to the activation of a smoke detector, children and adults can become familiar with the sound of the detector in advance of an emergency. Such advance familiarity will allow immediate recognition of the emergency noise signal in the event smoke is detected in a location other than the regular home of the children or adults.

Now describing the receiving/display unit or second unit 50 with more particularity, the flashing light signal is comprised to two independent portions. A first colored flashing light signal comprised of LEDs lights 60 (FIG. 2) is used to indicate the presence of people in need of rescue within the room. A second colored flashing light signal 62, also comprised of LEDs, is used to indicate the presence of pets in need of rescue within the room. The second colored flashing light signal 62 (FIG. 2) for indicating the presence of pets may be separately deactivated if pets are not present in the household.

First unit 10 is placed near any standard smoke alarm. First unit 10 detects the audible alarm given off by the smoke alarm when the smoke or heat of a fire is detected by the smoke alarm. The sound detector of first unit 10 senses this audible alarm and transmits a radio frequency (Rf) signal to the second unit 50 of the invention. Upon receiving the Rf signal the second unit sounds its own audible alarm and/or the LEDs 60, 62 of the second unit 50 are activated. It will be appreciated that the second unit 50 contains suction cups 68 on the rear face of the warning unit which allow the second unit to be attached to a window (FIG. 1) with the warning lights or LED's of the second unit facing out so they may be observed by anyone outside of the house and viewing the window.

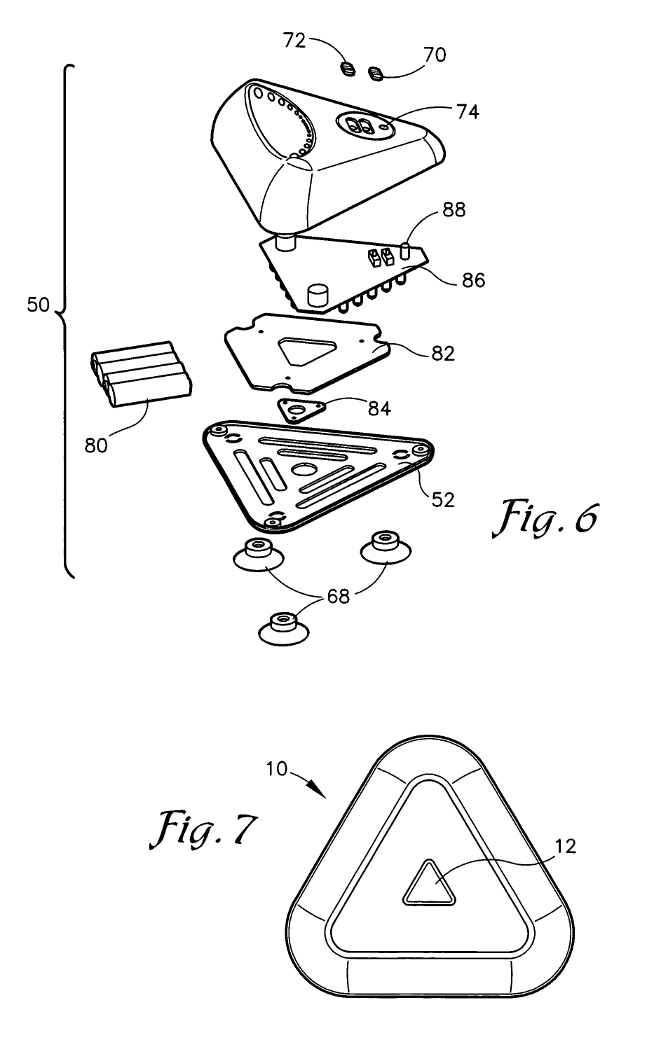

Upon activation of the second unit 50 the LED's begin to flash. The second unit in a preferred embodiment contains eighteen (18) red LEDs 60 and one large blue LED 62. The blue LED 62 can be turned on or off independently of the red LED's by a switch on the front face of the housing of the second unit. The blue LED is used to indicate that a pet is in the room. It will be appreciated by those skilled in the art that colored LEDs may be used in the device, Alternatively, color plates may be used with clear or white LEDs to produce various colors. In a preferred embodiment of the present invention, as shown in FIG. 6, a red color plate 82 and a blue color plate 84 are used with the present invention to produce the desired colors of the LEDs.

Referring now to FIGS. 4 and 6, second unit 50 contains an On/Standby/Off mode switch 70. This provides three modes of operation, On, Standby, and Off. The user can manually trigger the alarm by switching it to the ON position. In Standby mode, when second unit 50 receives the Rf signal from first unit 10 the second unit 50 is triggered into operation. It should be appreciated that if the second unit 50 is switched off it will not provided a warning in the event a smoke detector gives off an audible alarm.

The first unit 10 contains an On//Off mode switch 12 (FIG. 7). This provides two modes of operation—On and Off. The first unit also is provided with a “Register” position on switch 12 which is the position midway between On and Off. The register position allows the first unit 10 to detect one or more of the second warning unit 50 devices that are to be activated by the particular first unit.

The blue LED warning light 62 (FIG. 2) is provided with a separate On/Off switch 72 (FIGS. 4 and 6). This allows the separate activation/deactivation of the blue LED. If there is a pet in the room, the blue LED 62 may be switched to the “on” position. If a fire is detected by the smoke detector, blue LED 62 will be activated by the Rf signal received from the first unit 10 and the blue LED 62 will flash in addition to the red LEDs 60 on the rear face 52 of the unit 50.

Still referring to FIG. 6, the second unit 50 is equipped with a power indicator 74 in the form an LED adjacent the On/Standby/Off switch 70. If second unit 50 is turned off the power indicator LED 74 will not blink. When in Standby mode, and if the battery power is adequate the indicator LED 74 will flash once every 30 seconds. When an alarm is signaled or the unit is switched to the ON position, the indicator LED 74 will be steady on.

The first unit 10 and second units 50 each are powered by 4 AA batteries. In FIG. 6 batteries 80 are shown for second unit 50. If a “low battery” condition exists the first unit 10 or the second unit 50 will provide an warning the form of an audible “chirp” to make the user aware that battery renewal is required.

In the event of a false alarm the device may be reset by switching the off/on mode switch 12 to the OFF position. The device also may be turned off in this manner after an alarm has been signaled.

The red light or first light 10 warning 60 is comprised of eighteen (18) 5 mm LEDs which are set in the shape of a triangle. The triangle being a recognized warning shape with which emergency personnel will be familiar. The second light warning 62 is comprised on a single 10 mm blue LED positioned within the center of the triangle of red LED's. As previously stated the second light warning may be switched to the operational position to indicate the presence of a pet. The audible alarm provides approximately and 85 dB alarm which alternates in a one second on and one second off pattern. LEDs 60, 62 and the Rf receiver and the switches are mounted on circuit board 86. LED 88 is the light source for indicator 74 previously described.

Mounting of the device in a window is provided by three suction cup mounts 68 (FIG. 5) attached to the rear, light containing, face of the device. The first unit is mounted adjacent any convenient smoke detector by the use of screws or via double sided adhesive tape.

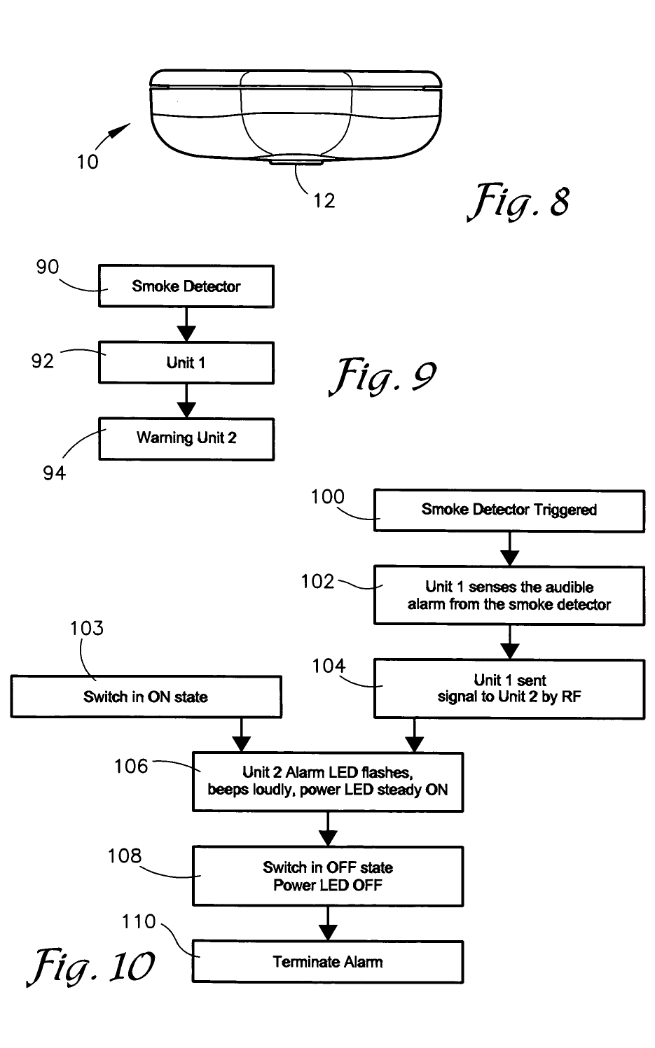

In FIG. 9 the order of the various devices in the inventive method is schematically presented. An activated smoke detector in Step 90 generates a noise that activates the sound detector that is a part of first unit 10 in Step 92. This activation of first unit 10 results in transmission of an Rf signal by unit 10 in Step 92. The Rf signal generated by the first unit 10 is then detected by second unit 50 which is operably responsive to first unit 10 in Step 94. The receiving of the Rf signal by second unit 50 activates second unit 50 which initiates the light and sound warning previously described.

Referring now to FIG. 10 the general scheme of operation will be described. The general sequence of operation of the inventive device is conditioned on the proper operation of a smoke detector. At Step 100, the smoke detector must detect the presence of a fire, either by the smoke or the heat that is generated by the combustion. On detection of the heat or combustion products of a fire, the smoke detector in Step 100 issues a noise alarm, usually some type of loud horn, by activation of the sound driver in the smoke detector. The noise of the sound in Step 100 alerts those in the dwelling of a fire in progress.

The noise generated by the smoke detector in Step 100 is then detected by first unit 10 in Step 102 as previously described. It will be appreciated that a user must insure that unit 10 and unit 50 are switched to the “on” state as shown in Step 103. The noise detector in first warning unit 10 then actuates the transmission of a radio frequency Rf signal in Step 104. The transmission of the Rf frequency in Step 104 is then received by second unit 50 in Step 104. The reception of the particular Rf frequency by second unit 50 causes activation of the selected LEDs of unit 50 and/or a sound alarm with which unit 50 may be equipped as shown in Step 106. Later, after the fire has been extinguished, or if the warning was a false alarm, the warning unit 50 can be switched to the off state in Step 108 which terminated the alarm as shown in Step 110.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive method and apparatus for providing a warning to persons in a dwelling and notice to rescue person outside the dwelling are constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

I claim:

1. A warning device responsive to the noise emitted by the activation of a smoke detector, said warning device comprising:
a first warning device positioned sufficiently close to the smoke detector for activation of a noise detector of said first device upon emission of an alarm noise from the smoke detector, said first device further comprising an Rf transmitter for transmitting an Rf signal upon detection of the emission by said noise detector,
a second warning device operably responsive to said first warning device, said second device having a receiver for receiving said Rf signal transmitted from said first device, said second device responding to said received Rf signal by generating a warning signal.

2. The device as claimed in claim 1 wherein said noise detector comprises a decibel detection device.

3. The device as claimed in claim 1 wherein said noise detector comprises a radio signal frequency detection device.

4. The device as claimed in claim 1 wherein said warning signal comprises a noise signal

5. The device as claimed in claim 1 wherein said warning signal comprises a light signal.

6. The device as claimed in claim 5 wherein said light signal is visible to persons on the exterior of the dwelling.

7. The device as claimed in claim 1 wherein said warning signal comprises a flashing light signal.

8. The device as claimed in claim 7 wherein said light signal is visible to persons on the exterior of the dwelling.

9. The device as claimed in claim 1 wherein said warning signal comprises a first and second flashing light said first flashing light being a first color and said second flashing light being a second color.

10. The device as claimed in claim 9 wherein said light signal is visible to persons on the exterior of the dwelling.

11. A method of warning individuals within a dwelling of the activation of a smoke detector noise alarm within the dwelling and of warning rescue personnel outside of the dwelling of the location of persons or pets within the building comprising:
positioning a first warning device sufficiently close to the smoke detector for activation of a noise detector contained in said first device upon emission of the alarm noise from the smoke detector,
positioning a second device on or adjacent to a window of the dwelling, detecting the alarm noise emitted from the smoke detector by said first warning device,
transmitting an Rf signal from said first device to a second device upon said detecting of the alarm noise emitted from the smoke detector,
receiving said Rf signal by said second unit,
activating said second unit upon said receiving said Rf signal, and
emitting a warning by said second unit upon said activating.

12. The device as claimed in claim 11 wherein said noise detector comprises a decibel detection device.

13. The device as claimed in claim 11 wherein said noise detector comprises a radio signal frequency detection device.

14. The device as claimed in claim 11 wherein said warning signal comprises a noise signal.

15. The device as claimed in claim 11 wherein said warning signal comprises a light signal.

16. The device as claimed in claim 15 wherein said light signal is visible to persons on the exterior of the dwelling.

17. The device as claimed in claim 11 wherein said warning signal comprises a flashing light signal.

18. The device as claimed in claim 7 wherein said light signal is visible to persons on the exterior of the dwelling.

19. The device as claimed in claim 11 wherein said warning signal comprises a first and second flashing light said first flashing light being a first color and said second flashing light being a second color.

20. The device as claimed in claim 19 wherein said light signal is visible to persons on the exterior of the dwelling.
